(19) United States
(12) Patent Application Publication
(10) Pub. No.: US 2003/0156749 A1
(43) Pub. Date: Aug. 21, 2003

(54) Pattern inspecting apparatus and pattern inspecting method

(75) Inventors: Toshie Nishiura, Tokyo (JP); Noriaki Ishio, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/200,167

(22) Filed: Jul. 23, 2002

(30) Foreign Application Priority Data
Feb. 15, 2002 (JP) 2002-039139

(51) Int. Cl. G06K 9/00

(52) U.S. Cl. 382/149; 382/151

(57) ABSTRACT

When inspecting a pattern of a semiconductor device, a basic pattern, which is used for correction of a mounted position when mounting a substrate on a support platform of the substrate, is recorded beforehand. Then, a deviation of a mounted position is corrected using the basic pattern. An image of the pattern, which is formed on the substrate mounted on the support platform, is obtained to detect a defect of the pattern judging from the obtained image. After production processing of the substrate progresses, if a shape of the basic pattern changes, a new pattern, which is used for correction of a mounted position when mounting a substrate on the support platform, is recorded temporarily. Then, using the new pattern registered temporarily, a deviation of a mounted position when the substrate is mounted on the support platform is corrected.

### BACKGROUND OF THE INVENTION

1. Field of the Invention

The present invention relates to a pattern inspecting apparatus and a pattern inspecting method. Moreover, as a specific application, the present invention relates to a pattern inspecting apparatus which detects a defect of a pattern formed on a substrate, and to a pattern inspecting method.

2. Background Art

FIG. 5 is a schematic diagram illustrating a conventional pattern inspecting apparatus 300. As shown in FIG. 5, in a pattern inspecting apparatus 300, light from a halogen lamp 8 enters into a deflecting plate 6 to deflect, and thereby a wafer 24 on a wafer stage 20 is irradiated with the light. An image of a pattern formed on the wafer 24, which is obtained here, is magnified by a objective lens 18. Then, the pattern image is photographed by a CCD camera 2. The photographed pattern image is transmitted to an image processor 44. In the image processor 44, the pattern image is sectioned on a pixel basis, and one gray scale is given to each pixel. Data of the gray scale is transmitted to a defect image detecting unit 36. In the defect image detecting unit 36, a defect of the pattern is detected by comparing density of both gray scales of corresponding pixels at the same position in a plurality of identical patterns formed on the same wafer 24.

FIG. 6 is a flowchart illustrating a pattern inspecting method which uses the pattern inspecting apparatus 300 as described above.

A conventional pattern inspecting method will be described with reference to FIGS. 5 and 6.

In the first place, an inspection program corresponding to the wafer 24, which is a target of inspection, is selected from among a plurality of inspection programs recorded on a program recording portion 32 (step S2). In this case, the inspection program is written beforehand in response to a state of the wafer 24. Conditions of inspection such as conditions of alignment and inspection sensitivity are set in the inspection program. This inspection program manages inspection. Patterns on each chip formed on the wafer 24 are automatically inspected in succession.

Next, the wafer 24 to be inspected is selected from a wafer cassette 28 (step S4). After pre-alignment of the selected wafer 24 is performed, a wafer transport system 26 transports the wafer 24 to the wafer stage 20 on which the wafer 24 is mounted (step S6).

Next, alignment is performed (step S8). Here, for the purpose of alignment, an arbitrary pattern formed on the wafer 24 is used as an alignment pattern. This alignment pattern is stored as an alignment pattern beforehand in the inspection program recorded on the program recording portion 32.

Alignment using an alignment pattern is used for correcting a deviation of position coordinates of the alignment pattern from position coordinates of the wafer stage 24 in a rotation direction.

After the alignment is performed, a defect of the pattern formed on the wafer 24 is detected by a defect detecting means 36 (step S16). As a result, coordinates of a pixel of the detected defect are recorded as defect coordinates on a defect coordinate recording portion 38 (step S18). In addition, if necessary, image data of the pattern where the defect has been detected is recorded as a defect image on a defect image recording portion 40 (step S20). In this manner, a chip formed on the wafer 24 is inspected in succession.

It is to be noted that in the case of such pattern inspection, not all of the detected defective patterns include a defect. Therefore, after completing the inspection by detecting a defect and by recording defect coordinates and a defect image, final judgment of a failure is often performed by manual operation, that is to say, by observing or reviewing the detected defective pattern again according to the recorded data (step S36).

In this manner, if the observation (review) is performed, after defect inspection is finished, alignment is performed using the same alignment pattern, which has been used for the inspection, to mount the wafer 24 on the wafer stage 20 (step S28). However, as a result of the manufacturing process of the wafer 24 progressing after inspection, if the alignment pattern formed on the wafer 24 has a shape different from that at the time of the inspection by which the defect coordinates have been detected, the alignment cannot be performed using the stored alignment pattern, whereby observation (review) cannot be carried out. In such a case, an alignment pattern which conforms to the manufacturing process must be recorded again to write an inspection program again according to the alignment pattern (step S50).

In addition, since the alignment is performed using an arbitrary pattern, as an alignment pattern, on the wafer 24, there is a possibility that the alignment pattern in itself is defective. In this case, the alignment for inspection (step S28) cannot be performed. Therefore, even in such a case, a new alignment pattern must be registered again to write an inspection program again (step S50).

However, writing a program, which conforms to a shape of the pattern on the wafer 24, again for the purpose of inspection and observation (review) as described above requires much time for pattern inspection, causing a delay in production, and, in turn, leading to an increase in production cost.

Moreover, it is also possible to perform observation (review) by displaying a defect image, which is recorded on the defect image recording portion 40, on the personal computer monitor 46 to use the displayed defect image at the time of inspection. If the observation is performed in this way, it is not necessary to mount the wafer 24 on the wafer stage 20 again for the observation (review), which eliminates the need for alignment. Accordingly, even if the shape of the pattern on the wafer 24 changes, it is not necessary to write the inspection program again.

However, a capacity of the defect image recording portion 40 is limited. On the other hand, patterns in which a defect is detected may include a pattern that is not defective in reality. Because of it, an enormous amount of defect image data is often transacted. In such a case, not all defect images can be recorded on the defect image recording portion 40. Additionally, although the total number of images to be recorded can be limited, it is not possible to selectively record a defect image in response to a defect, that is to say, to specify only a necessary part of a defect for recording, or the like by observation of the operator. Therefore, it is difficult to perform observation (review) at a time in succession after performing successive inspection at a time to record all defect images. Thus, even if observation (review) is performed using a defect image recorded at the time of defect inspection, much time is often required for pattern inspection.

### SUMMARY OF THE INVENTION

The present invention aims to solve the problems described above, and to perform a pattern inspection quickly effectively. The present invention proposes an improved pattern inspecting apparatus and an improved pattern inspecting method.

According to one aspect of the present invention, a pattern inspecting apparatus comprises an image obtaining means for obtaining an image of a pattern formed on a substrate which is mounted on a support platform, and a position correction means for recording a basic pattern beforehand. The basic pattern is used for correction of a mounted position when the substrate is mounted on the support platform, and the position correction means corrects a deviation of the mounted position using the basic pattern. Further, the pattern inspecting apparatus comprises a defect detecting means for detecting a defect of the pattern judging from the image obtained by the image obtaining means, and a temporary recording portion for temporarily recording a new pattern used for correction of a mounted position when the substrate is mounted on the support platform, if a mounted position can not be corrected using the basic pattern. And the position correction means can correct a deviation of the mounted position when the substrate is mounted on the support platform, using the new pattern recorded on the temporary recording portion.

Accordingly, when performing observation (review) again after detecting a defect, even if a shape of the basic pattern used at the time of defect detection changes, it is not necessary to rewrite the inspection program. In addition, even if the deviation of the mounted position could not be corrected because the basic pattern in itself, which is recorded in the inspection program, has a defect, it is possible to cope with this problem only by registering a new pattern temporarily.

In another aspect of the present invention, a pattern inspecting apparatus comprises an image obtaining means for obtaining an image of a pattern formed on a substrate which is mounted on a support platform and a position correction means for recording a basic pattern beforehand. The basic pattern is used for correction of a mounted position when the substrate is mounted on the support platform, and the position correction means corrects a deviation of the mounted position using the basic pattern. Further, the pattern inspection apparatus comprises a defect detecting means for detecting a defect of the pattern judging from the image obtained by the image obtaining means, a defect size judging means for judging a size of the defect detected by the defect detecting means; and a defect image recording portion for selecting only a pattern image, the defect of which has a size within a given range, from among the patterns where the defect has been detected, and recording the selected image.

Accordingly, the defect image recording portion having a limited capacity can be used effectively. Moreover, because only images which require observation are recorded selectively, efforts required for observation can be relaxed.

In another aspect of the present invention, in a pattern inspecting method for inspecting a defect of a pattern formed on a substrate, an inspection program that is set beforehand is selected. A substrate to be inspected is selected according to the inspection program and is mounted at a given position. A deviation of a mounted position of the substrate is corrected by using a basic pattern formed on the substrate. If a mounted position cannot be corrected using the basic pattern, a new pattern is temporarily recorded and a deviation of the mounted position of the substrate is corrected using the new pattern. A defect of patterns of the substrate is detected.

Accordingly, when performing observation gain after detecting a defect, even if a shape of the basic pattern used at the time of defect detection changes, it is not necessary to rewrite the inspection program. In addition, even if the deviation of the mounted position could not be corrected because the basic pattern in itself, which is recorded in the inspection program, has a defect, it is possible to cope with this problem only by registering a new pattern temporarily.

### BRIEF DESCRIPTION OF THE DRAWINGS

FIG. 1 is a conceptual diagram illustrating a pattern inspecting apparatus according to a first embodiment of the present invention;

FIG. 2 is a flowchart illustrating a method for detecting a defect pattern according to the first embodiment of the present invention;

FIG. 3 is a diagram illustrating a pattern inspecting apparatus according to a second embodiment of the present invention;

FIG. 4 is a flowchart illustrating a method for inspecting a pattern according to the second embodiment of the present invention;

FIG. 5 is a schematic diagram illustrating a conventional pattern inspecting apparatus;

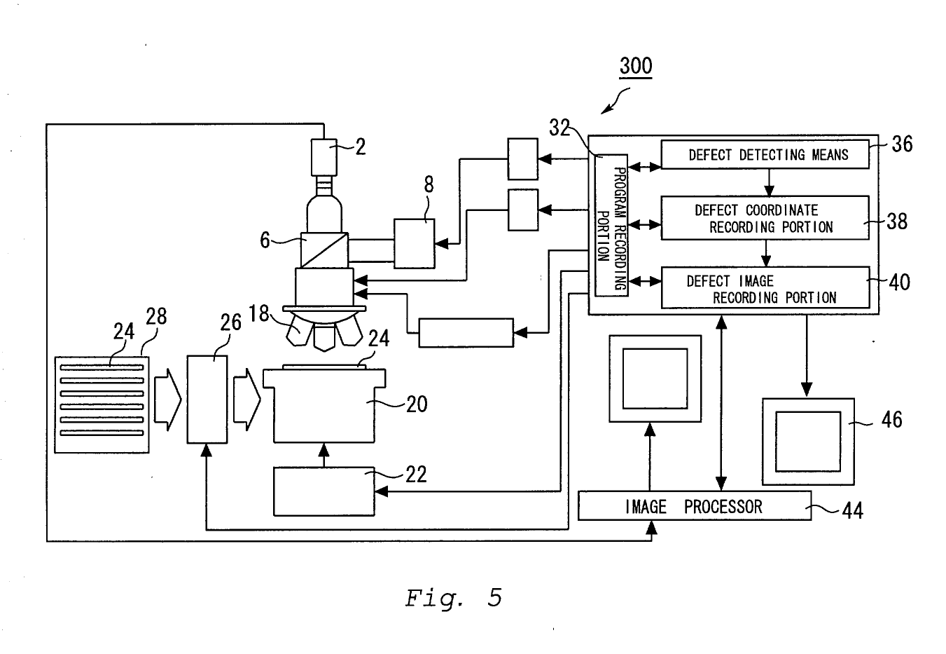

FIG. 6 is a flowchart illustrating a pattern inspecting method which uses the pattern inspecting apparatus.

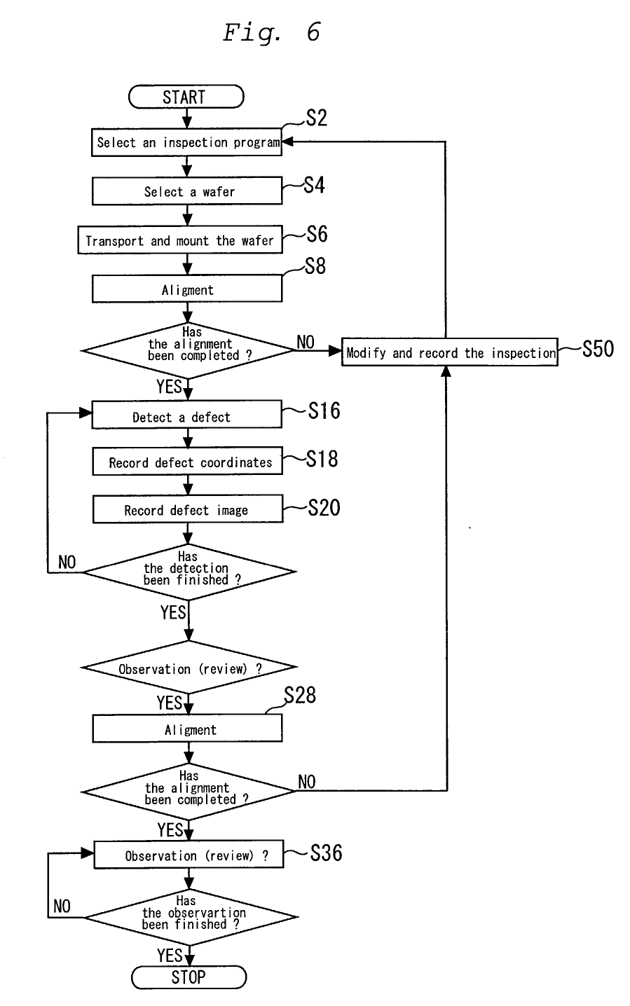

### DETAILED DESCRIPTION OF THE PREFERRED EMBODIMENTS

Embodiments of the present invention will be described with reference to the drawings hereinafter. In each figure, the same or equivalent parts are designated by similar reference numerals, and the description thereof will be simplified or omitted. First Embodiment

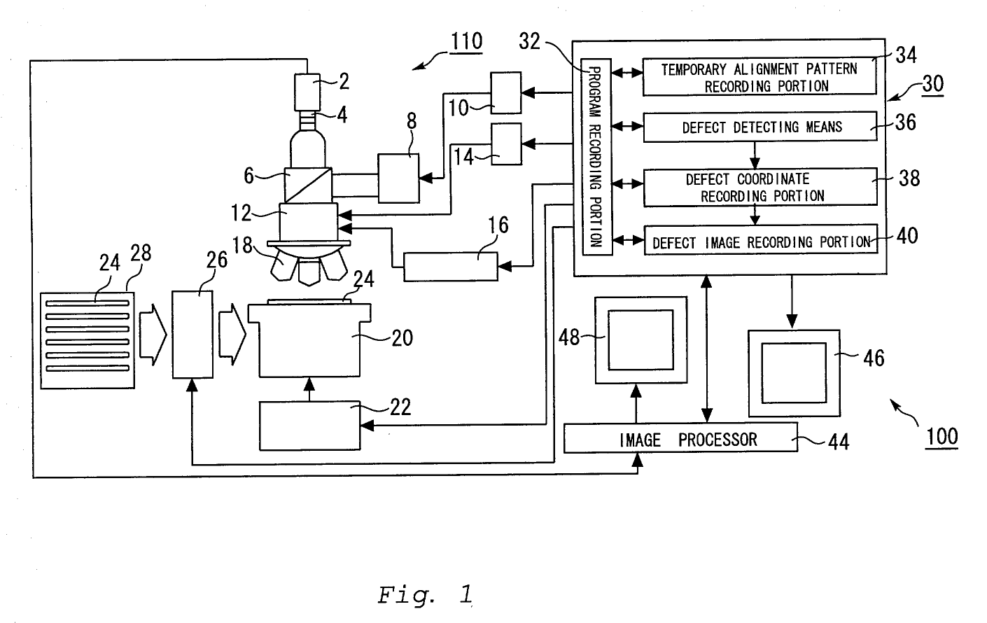

FIG. 1 is a conceptual diagram illustrating a pattern inspecting apparatus 100 according to a first embodiment of the present invention. In the figure, the pattern inspecting apparatus 100 comprises an optical microscope 110, a wafer transport system 26, a host personal computer 30, and an image processor 44.

The optical microscope 110 comprises a CCD camera 2. The CCD camera 2 comprises a relay lens 4. In addition, the optical microscope 110 comprises a deflecting plate 6. A halogen lamp 8 is connected to the deflecting plate 6; and a lighting power supply 10 is connected to the halogen lamp 8.

A revolver 12 is coupled to the under side of the deflecting plate 6. An autofocus 14 and a revolver controller 16 are connected to the revolver 12. Further, an objective lens 18 is coupled to the underside of the revolver 12.

Moreover, a wafer stage 20 is placed at a position that faces the objective lens 18; and a stage controller 22 is connected to the wafer stage 20. Additionally, a wafer 24 is mounted on the wafer stage 20.

As described above, the optical microscope 110 according to the first embodiment is configured to include the CCD camera 2, the relay lens 4, the deflecting plate 6, the halogen lamp 8, the lighting power supply 10, the revolver 12, the autofocus 14, the revolver controller 16, the objective lens 18, the wafer stage 20 and the stage controller 22.

In addition, the wafer transport system 26 is placed between the wafer stage 20 and the wafer cassette 28. In a wafer cassette 28, the wafer 24 waiting for inspection is stored.

In addition, the pattern inspecting apparatus 100 comprises the host personal computer 30. The host personal computer 30 is connected to the lighting power supply 10, the autofocus 14, the revolver controller 16, and the stage controller 22, which are included in the optical microscope 110. At the same time, the host personal computer 30 is connected to a personal computer monitor 46.

The host personal computer 30 is provided with a program recording portion 32, a temporary alignment pattern recording portion 34, a defect detecting means 36, a defect coordinate recording portion 38, and a defect image recording portion 40.

Moreover, the pattern inspecting apparatus 100 comprises the image processor 44. The image processor 44 is connected to the host personal computer 30, an image monitor 48, and the CCD camera 2 of the optical microscope.

Next, functions of the pattern inspecting apparatus 100 configured in this manner will be described.

In the optical microscope 110, light from the halogen lamp 8 enters into the deflecting plate 6 to deflect. As a result, the wafer 24 on the wafer stage 20 is irradiated with the light. A pattern image obtained here is magnified by the objective lens 18. The magnified pattern image is transmitted by the relay lens 4, and is then photographed by the CCD camera 2.

At this time, the optical microscope 110 is connected to the host personal computer 30, and is managed by an inspection program recorded on the program recording portion 32. Accordingly, the optical microscope 110 is so devised that it can automatically successively inspect a plurality of patterns formed on the wafer 24.

More specifically, the host personal computer 30 controls the lighting power supply 10 according to the inspection program recorded on the inspection program recording portion 32. Accordingly, at the time of inspection, the halogen lamp 8 can automatically emit light having illuminance required for the inspection.

Further, the host personal computer 30 controls the revolver controller 16 according to the inspection program. Therefore, at the time of inspection, the revolver controller 16 can automatically adjust sensitivity of the objective lens 18 so that the sensitivity becomes a level required for the inspection.

Furthermore, the host personal computer 30 controls the autofocus 14 according to the inspection program. This permits the autofocus 14 to automatically adjust a focus of the objective lens 18.

Additionally, the host personal computer 30 controls the stage controller 22 according to the inspection program. The host personal computer 30 compares position coordinates of an alignment pattern recorded in the inspection program, or position coordinates of a temporary alignment pattern recorded on the temporary alignment pattern recording portion 34, with position coordinates of the wafer stage 20 so as to detect a deviation of the wafer stage 20 in a rotation direction. Moreover, the host personal computer 30 calculates an angle of rotation used for correcting the detected deviation, and then transmits the resultant angle of rotation to the stage controller 22. According to the resultant angle of rotation, the stage controller 22 automatically rotates the wafer stage 20 to correct the deviation of the wafer stage 20 in the rotation direction.

On the inspection program recording portion 32 of the host personal computer 30, an inspection program for various patterns is recorded. In addition, in the inspection program, a basic alignment pattern is recorded. Nevertheless, if alignment cannot be performed by this basic alignment pattern, it is possible to record a new alignment pattern on the temporary alignment pattern recording portion 34 as a temporary alignment pattern as the need arises, and to select this temporary alignment pattern for use.

An image photographed by the CCD camera 2 is transmitted to the image processor 44. Using the image monitor 48 connected to the image processor, this photographed image can be observed.

In addition, the image processor 44 sections the image transmitted from the CCD camera 2 on a basis of pixel, and then gives one of 256-step gray scales to each pixel. The gray scale data obtained here, relating to the image, is transmitted to the defect detecting means 36 of the host personal computer 30.

The defect detecting means 36 can detect a defect by comparing both gray scales of corresponding pixels at the same position in a plurality of identical patterns formed on the inspected wafer 24. On the defect coordinate recording portion 38 of the host personal computer 30, coordinates of a pixel where the defect has been detected can be recorded in this manner. The defect coordinates express a position relative to the wafer stage 20 as coordinates. Further, on the defect image recording portion 40, an image of a pattern where the defect has been detected can be recorded as a defect image.

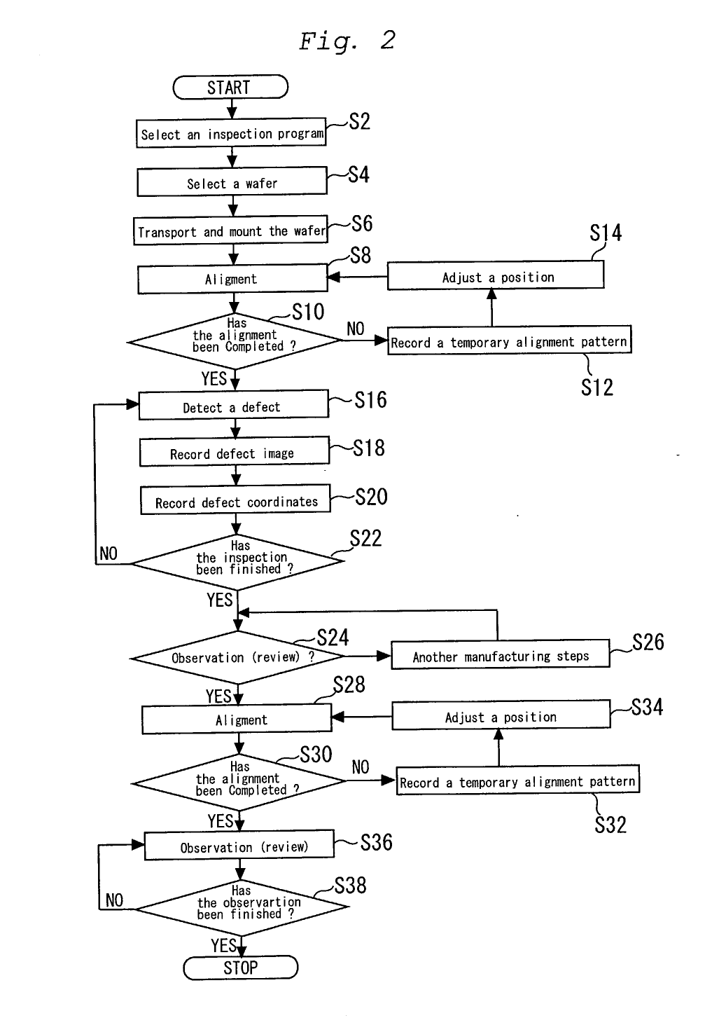

FIG. 2 is a flowchart illustrating a method for detecting a defect pattern according to the first embodiment of the present invention.

A pattern detection method using the pattern inspecting apparatus 100 will be described with reference to FIG. 2 below.

To begin with, from among various inspection programs recorded on the program recording portion 32 of the host personal computer 30, a required inspection program is selected (step S2).

Next, the wafer 24 is selected (step S4). Here, according to the selected inspection program, information about the wafer 24 to be transported is transmitted from the host personal computer 30 to the wafer transport system 26. According to the information, the wafer transport system 26 selects the required wafer 24 from the wafer cassette 28.

The wafer 24 selected in this manner is transported by the wafer transport system 26. The wafer 24 is then mounted on the wafer stage 20 after pre-alignment (step S6).

Next, alignment is performed (step S8). In this step, the angle of rotation required for correction, which is calculated in the host personal computer 30 using an alignment pattern, is transmitted to the wafer stage 20. In response to this, the wafer stage 20 rotates only by this angle of rotation.

Next, a judgment is made as to whether or not the alignment has been completed (step S10). In this case, if the alignment could not be performed due to a defect of an arbitrary pattern used as the alignment pattern, a new arbitrary pattern is selected from among patterns formed in the wafer 24. This new arbitrary pattern is temporarily recorded on the temporary alignment pattern recording portion 34 as a temporary alignment pattern (step S12). Moreover, if a position of a temporary alignment pattern deviates from that of the original alignment pattern, the position is adjusted (step S14). Here, in the host personal computer 30, the deviation of the temporary alignment pattern position from the original alignment pattern position is calculated with reference to a chip angle to rotate the wafer stage only by the deviation.

Next, the alignment is performed again while keeping in this state (step S8). In this step, alignment is performed using the temporary alignment pattern recorded on the temporary alignment pattern recording portion 34.

Whether or not the alignment has been completed is checked (step S10). If the alignment could be performed, the detection of a pattern defect is carried out (step S16). In this step, a signal is transmitted from the host personal computer 30 to the lighting power supply 10, the revolver controller 16, and the autofocus 14 according to the inspection program. As a result, the optical microscope 110 is set so as to satisfy conditions required for the inspection. While keeping in this state, emission of light from the halogen lamp 8 is started, and then an image of the pattern formed in the wafer 24 is obtained by photographing using the CCD camera 2. The image obtained here is transmitted to the image processor 44 where a gray scale is given to each pixel. The gray scale data of this image is transmitted to the defect detecting means 36 of the host personal computer 30. In the defect detecting means 36, a defect pattern is detected on the basis of this gray scale data.

Next, coordinates of a pixel of the detected defect pattern are recorded as defect coordinates (step S18). Additionally, an image of the defect pattern is recorded as a defect image (step S20).

Next, a judgment is made as to whether or not another pattern in the same wafer is inspected in succession (step S22). Here, if another pattern is inspected in succession, the detection of a defect of an appropriate pattern is carried out (step S16).

If the pattern inspection is finished, a judgment is made again as to whether or not the detected defect pattern is observed (reviewed) (step S24). Here, if the observation (review) is not performed immediately, but the observation (review) is performed later after proceeding to the next manufacturing process, the process can be executed (step S26) prior to the observation (review), which can be performed when the necessity arises.

If the observation (review) is performed, alignment of the wafer 24 is performed again (step S28). In this step, to begin with, alignment is performed using the original alignment pattern recorded in the inspection program; or if a temporary alignment pattern is recorded on the temporary alignment pattern recording portion 34, the alignment is performed using the temporary alignment pattern.

Next, a judgment is made as to whether or not the alignment has been completed (step S30). Here, if manufacturing process of the wafer 24 progresses after the inspection during which the defect has been detected, and if alignment of the wafer 24 could not be performed due to a change in the shape of the alignment pattern, a new temporary alignment pattern is recorded (step S32). In this case, the temporary alignment pattern to be recorded supports a pattern after the manufacturing process of the wafer 24. Next, if a position of a temporary alignment pattern is deviated from that of the original alignment pattern, the position is adjusted using a chip angle (step S34).

Next, alignment is performed again while keeping in this state (step S28). Here, the temporary alignment pattern recorded on the temporary alignment pattern recording portion 34 is selected to perform the alignment.

Next, on the basis of defect coordinates recorded on the defect coordinate recording portion 38, observation (review) is performed (step S36). Here, on the basis of defect coordinates recorded on the defect coordinate recording portion 38, observation (review) of a pattern at the defect coordinates is performed again by focusing on the pattern at the defect coordinate. After that, a judgment is made as to whether or not there is a defect in reality by observing the pattern at the recorded defect coordinates.

Next, a judgment is made as to whether or not a pattern at another recorded defect coordinates is observed (reviewed) (step S38). If the judgment is made to observe (review) the pattern, the observation (review) is performed (step S36) by focusing on the defect pattern according to the coordinates. On the other hand, if the process ends, the inspection of the semiconductor device is completed.

The steps described above eliminate the need for writing a new program every time a shape of a pattern formed in the wafer 24 changes. Temporarily registering a new alignment pattern, and using this temporarily recorded alignment pattern, enables support for a change in the shape of the alignment pattern instead. Accordingly, a time required for inspection can be reduced drastically, which improves productivity of the semiconductor device.

It is to be noted that although the inspection using the optical microscope 110 is described in this embodiment, the present invention is not limited to this. The present invention covers a pattern inspecting apparatus which performs alignment for inspection using other microscopes including an optical microscope having another structure, and an electron microscope.

Additionally, in this embodiment the case is described where the host personal computer 30 and the image processor 44 are connected to the optical microscope 110 so that the inspection is automatically performed. However, employed units are not limited to the host personal computer 30 and the image processor 44 as long as the units have functions of managing pattern inspection, performing image processing, and detecting a pattern defect.

Second Embodiment

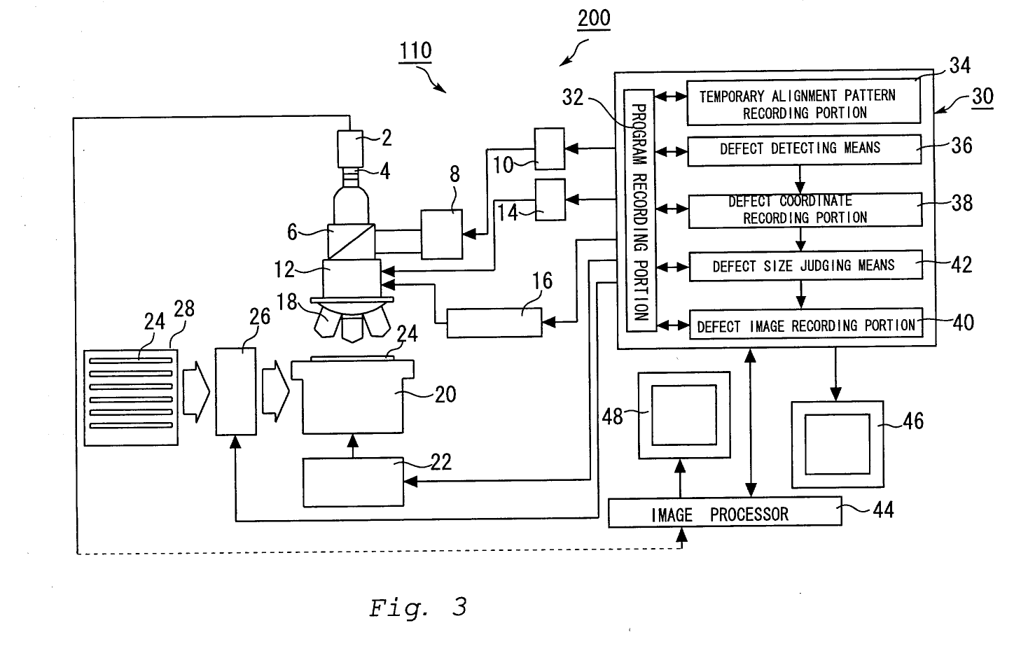

FIG. 3 is a diagram illustrating a pattern inspecting apparatus 200 according to a second embodiment of the present invention. The pattern inspecting apparatus 200 further comprises a defect size judging means 42 in addition to the pattern inspecting apparatus 100 described in the first embodiment.

The host personal computer 30 comprises the defect size judging means 42.

The defect size judging means 42 can determine a size of a defect pattern, which is detected by the defect detecting means 36, judging from the number of pixels detected as the defect. As a result, if the size of the defect pattern is smaller than a given size, the defect image recording portion 40 records the defect image. On the other hand, if the size of the defect pattern is larger than the given size, the defect image is not recorded. In this manner, the pattern inspecting apparatus 200 can record only a pattern having a small-size defect as a defect image selectively from among patterns, which have been judged as defects by the defect detecting means 36, on the defect image recording portion 40.

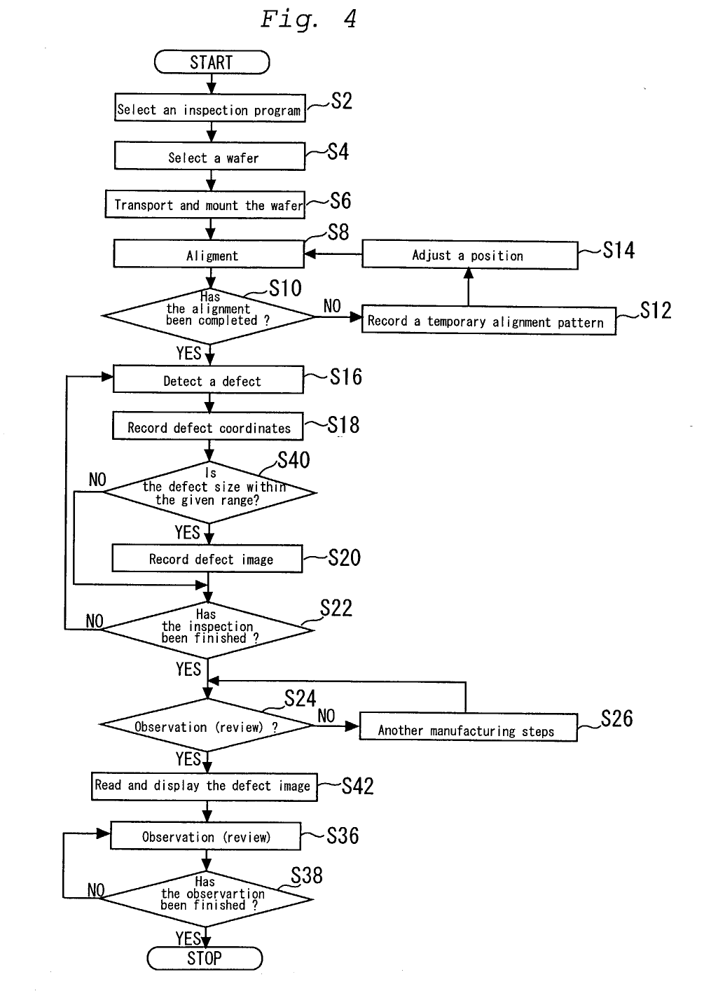

FIG. 4 is a flowchart illustrating a method for inspecting a pattern according to the second embodiment of the present invention. A pattern inspecting method using the pattern inspecting apparatus 200 will be described with reference to FIG. 4 below.

In the first place, as is the case with the first embodiment, an inspection program is selected (step S2). Then, according to this selected inspection program, a wafer is selected (step S4). The wafer transport system 26 transports the wafer 24 to mount it on the wafer stage 20 (step S6).

Next, alignment is performed (step S8). In this case, if the alignment could not be executed, then a temporary alignment pattern is recorded (step S12), position correction is performed (step S14), and the alignment is performed again using the temporary alignment pattern (step S8).

Next, inspection of a pattern is started to detect a defect (step S16). In addition, defect coordinates are recorded (step S18).

Here, in the second embodiment, a judgment is made as to whether or not a size of a detected defect pattern is within the range of a given size (step S40). If the size of the defect pattern is judged to be smaller than the given size, the defect image is recorded on the defect image recording portion 40 (step S20). On the other hand, if the size is judged to be larger than the given size, the process proceeds to the next step without recording the defect image. This is because, in reality, there is a high possibility that defects which are smaller than a given range include a pattern that is not a defect.

Next, a judgment is made as to whether or not the inspection is finished (step S22). If the inspection is continued, a defect is detected and recorded (steps S16 through S20). If the inspection is finished, a judgment is made as to whether or not observation (review) is performed (step S22). Here, if the observation (review) is not performed, the process proceeds to another manufacturing process (step S26). In this case, the observation (review) can be performed when the necessity arises.

If the observation (review) is performed, the defect image recorded on the defect image recording portion 40 is read to display the defect image on the personal computer monitor 46 (step S42). In this case, by observing the displayed image to compare it with an image of the same pattern, a judgment is made as to whether or not the image recorded as the defect is really defective (step S36).

Then, a judgment is made as to whether or not observation (review) is continuously performed (step S38). If the observation (review) is continuously performed, the observation (review) is performed (step S36). If the observation is not continued, the pattern inspection is finished.

The steps described above permits only defect images having a defect size less than or equal to a given value to be selected and recorded. Patterns detected as defects as a result of inspection may include patterns that are not a defect in reality. When a defect having a size larger than a certain size is detected, even if the observation (review) is not performed again for judgment, there is a high possibility that this defect is a fatal defect. According to the method described in the second embodiment, it is possible to avoid recording images of patterns holding a high possibility of a defect. Only images of patterns, which require observation (review) to judge as to whether or not the patterns are really defective, can be recorded as defect images. Therefore, the defect image recording portion 40 having limited capacity can be utilized effectively; in addition, the number of patterns to be observed (reviewed) can be reduced effectively. Moreover, according to this method, it is not necessary to perform alignment again for observation (review). Accordingly, a time required for inspection can be reduced, whereby the productivity of semiconductor production can be improved.

Incidentally, in the second embodiment, the case where the host personal computer 30 comprises the defect size judging means 42 is described. However, the present invention is not limited to this. As long as a unit has a function of judging a size of a defect image, the unit may be employed for the present invention.

In the present invention, a substrate corresponds to, for example, the wafer 24 in the first and second embodiments; a support platform corresponds to, for example, the wafer stage 20; and an image obtaining means corresponds to, for example, the optical microscope 110. In addition, in the present invention, a basic pattern corresponds to, for example, an alignment pattern registered first in the inspection program in the first and second embodiments. In addition, a new pattern corresponds to, for example, a temporary alignment pattern recorded on the temporary alignment pattern recording portion 34.

In addition, in the present invention, a position correction means corresponds to, for example, the stage controller 22 and the host personal computer 30 in the first and second embodiments; and a temporary recording portion corresponds to, for example, the temporary alignment pattern recording portion 34. In addition, in the present invention, a defect detecting means corresponds to, for example, the image processor 44 and the defect detecting means 36; and a defect position recording portion corresponds to, for example, the defect coordinate recording portion 38.

In addition, in the present invention, an adjusting means corresponds to, for example, the stage controller 22 and the host personal computer 30 in the first and second embodiments. Moreover, in the present invention, a defect size judging means corresponds to, for example, the defect size judging means 42 in the second embodiment; and a defect image recording portion corresponds to, for example, the defect image recording portion 40.

Additionally, for example, in the first and second embodiments, a program selecting step of the present invention is performed by executing step S2. For example, a substrate mounting step is performed by executing steps S4, S6. In addition, for example, in the first and second embodiments, a position correcting step of the present invention is performed by executing step S8; and a defect detecting step is performed by executing step S16. In addition, for example, in the first and second embodiments, a defect position recording step of the present invention is performed by executing step S18.

In addition, for example, in the first and second embodiments, first and second temporary recording steps of the present invention are performed by executing step S12 and S32, respectively; and first and second temporary position correcting steps are performed by executing step S8 and S28, respectively. In addition, for example, in the first embodiment, an observing step of the present invention is performed by executing step S36.

Moreover, for example, in the first and second embodiments, a position adjusting step of the present invention is performed by executing step S14 and S34.

Furthermore, for example, in the second embodiment, a defect size judging step of the present invention is performed by executing step S40; and a defect image recording step is performed by executing step S20.

The features and the advantages of the present invention as described above may be summarized as follows.

According to one aspect of the present invention, it is possible to correct a deviation of a mounted position of a substrate by replacing a basic pattern written in an inspection program with a new pattern. Accordingly, when performing observation (review) again after detecting a defect, even if a shape of the basic pattern used at the time of defect detection changes, it is not necessary to rewrite the inspection program. In addition, even if the deviation of the mounted position could not be corrected because the basic pattern in itself, which is recorded in the inspection program, has a defect, it is possible to cope with this problem only by registering a new pattern temporarily. This can reduce expenses and a time required for inspection, allows inspection and observation in all steps, and improves productivity of semiconductor production.

In another aspect of the present invention, images of patterns can be recorded selectively so that the images are recorded only when a size of a detected defect is within a given range. Accordingly, the defect image recording portion having a limited capacity can be used effectively. Moreover, because only images which require observations (review) are recorded selectively, efforts required for observation can be relaxed. Accordingly, inspection and observation can be performed in all steps with expenses and a time required for inspection reduced, whereby productivity of semiconductor production can be improved.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2002-039139, filed on Feb. 15, 2002 including specification, claims, drawings and summary, on which the Convention priority of the present application is based, are incorporated herein by reference in its entirety.

1. A pattern inspecting apparatus comprising:
an image obtaining means for obtaining an image of a pattern formed on a substrate which is mounted on a support platform;
a position correction means for recording a basic pattern beforehand, the basic pattern being used for correction of a mounted position when the substrate is mounted on the support platform, and said position correction means correcting a deviation of the mounted position using the basic pattern; and
a defect detecting means for detecting a defect of the pattern judging from the image obtained by said image obtaining means; and
a temporary recording portion for temporarily recording a new pattern used for correction of a mounted position when the substrate is mounted on the support platform, if a mounted position can not be corrected by using the basic pattern,
wherein the position correction means can correct a deviation of the mounted position when the substrate is mounted on the support platform, using the new pattern recorded on said temporary recording portion.

2. A pattern inspecting apparatus according to claim 1, further comprising a defect position recording portion for recording a position of the pattern, where the defect has been detected, in the substrate.

3. A pattern inspecting apparatus according to claim 1, further comprising:
a defect size judging means for judging a size of the defect detected by said defect detecting means; and
a defect image recording portion for selecting only a pattern image, the defect of which has a size within a given range, from among the patterns where the defect has been detected, and recording the selected image.

4. A pattern inspecting apparatus according to claim 1, further comprising an adjusting means for adjusting the deviation of the position of the new pattern from that of the basic pattern.

5. A pattern inspecting apparatus comprising:
an image obtaining means for obtaining an image of a pattern formed on a substrate which is mounted on a support platform;
a position correction means for recording a basic pattern beforehand, the basic pattern being used for correction of a mounted position when the substrate is mounted on the support platform, and said position correction means correcting a deviation of the mounted position using the basic pattern;
a defect detecting means for detecting a defect of the pattern judging from the image obtained by said image obtaining means;
a defect size judging means for judging a size of the defect detected by said defect detecting means; and
a defect image recording portion for selecting only a pattern image, the defect of which has a size within a given range, from among the patterns where the defect has been detected, and recording the selected image.

6. A pattern inspecting method for inspecting a defect of a pattern formed on a substrate, said pattern inspecting method comprising:
a program selecting step for selecting an inspection program that is set beforehand;
a substrate mounting step for selecting a substrate to be inspected according to the inspection program to mount the selected substrate at a given position;
a position correcting step for correcting a deviation of a mounted position of the substrate using a basic pattern formed on the substrate; and
a defect detecting step for detecting a defect of the pattern,
wherein, when said position correcting step is performed, if a mounted position cannot be corrected using the basic pattern, a position correcting step comprises a first temporary recording step for recording a new pattern temporarily, and a first temporary position correcting step for correcting a deviation of the mounted position of the substrate using the new pattern recorded at said first temporary recording step.

7. A pattern inspecting method according to claim 6, further comprising, a defect position recording step for recording a position of the defect pattern if the pattern has a defect.

8. A pattern inspecting method according to claim 6, further comprising;
an observing step for observing the pattern where the detect has been detected,
wherein, when said observing step is performed, if a mounted position cannot be corrected by using the basic pattern or the new pattern recorded at said first temporary recording step, said observing step comprises a second temporary recording step for recording a new pattern temporarily, and a second temporary position correcting step for correcting a deviation of the mounted position of the substrate using the new pattern recorded at said second temporary recording step.

9. A pattern inspecting method according to claim 6, further comprising;
a defect size judging step for judging a size of the defect detected in said defect detecting step; and
a defect image recording step for selecting only a pattern image, the defect of which is judged to have a size within a given range in the defect size judging step, and recording the selected image.

10. A pattern inspecting method according to claim 6, further comprising a position adjusting step for adjusting a deviation of the position of the new pattern from that of the basic pattern after said first temporary recording step.
